(19) United States
(12) Patent Application Publication
(10) Pub. No.: US 2009/0049183 A1
(43) Pub. Date: Feb. 19, 2009

(54) Method of Client-Side Form Authentication

(76) Inventors: Tony E. Thompson, Fort Wayne, IN (US); Matt W. Fardig, Boonville, IN (US); Rick W. German, Carmel, IN (US)

Correspondence Address: TAFT STETTINIUS & HOLLISTER LLP, ONE INDIANA SQUARE, SUITE 3500, INDIANAPOLIS, IN, 46204, US

(21) Appl. No.: 12/190,673

(22) Filed: Aug. 13, 2008

Related U.S. Application Data
(60) Provisional application No. 60/955,436, filed on Aug. 13, 2007.

(51) Int. Cl. G06F 15/173

(52) U.S. Cl. 709/229

(57) ABSTRACT

A method of form authentication enables a user to be automatically authenticated to a web application without being prompted for login credentials. Particularly, by use of “client-side” processing, the number and variety of web applications that can be successfully authenticated against may be increased. Client-side processing allows the login page scripting to execute prior to the form authentication process. The ability to execute client-side logic prior to authentication may significantly increase the number of web applications that can be successfully background authenticated against.

### RELATED APPLICATIONS

This application claims the benefit of U.S. Provisional Application 60/955,436 filed Aug. 13, 2007, which is hereby incorporated by reference herein.

### BACKGROUND OF THE INVENTION

1. Field of the Invention

The present invention relates generally to a method of signing-on to information systems.

2. Description of the Related Art

When client users access multiple information systems on an organization's web site or network, they are often required to sign-on separately to each of the information systems. Thus, users may be required to remember and manage a separate account name and password to each of the various information systems. Password and account management has always been a concern for organizations that manage large corporate networks. The cost of managing forgotten user accounts and passwords across several applications on an average-sized network can be staggering, and may cause frustration for both users and those who manage the user accounts and passwords.

### SUMMARY OF THE INVENTION

The present invention is directed to software that enables client users to sign-on a single time per login to a web site in order to access multiple information systems on the web site, such as web applications, file systems, databases, terminal servers, and Citrix Metaframe servers. The method of the present invention provides single sign-on services for web applications, servers, file systems, and databases. Single sign-on services provide background authentication to all services through the method of the present invention. With single sign-on, the users need to authenticate only once in order to access any of the corporate applications and services.

In a perfect world there would be one security database that provides access to all corporate applications and servers. However, in the real world, network and information technology professionals have to deal with individual users that are referenced in multiple security databases, with different account names and various passwords. The present invention provides a means for users to store and manage their various account IDs and passwords as part of the single sign-on process to web applications and services that run within the web network system. The present invention simplifies the management of multiple account credentials and provides a means of storing sensitive information within the directory services database. Within the relay, the login page may be requested and altered before the login page is sent to the browser of the client computer.

An advantage of the present invention is that it enables single sign-on for web applications, file systems, databases, Citrix Metaframe, Microsoft Terminal Server, and published applications.

Another advantage is that authentication credentials are securely stored.

Yet another advantage is that attributes may be dynamically substituted to simplify single sign-on management.

A further advantage is that single sign-on forms to web applications may be created.

An additional advantage is that software does not have to be placed on the client computer for a web-based single sign-on to operate.

### BRIEF DESCRIPTION OF THE DRAWING

The above-mentioned and other features and advantages of the invention will become more apparent to one with skill in the art upon examination of the following FIGURE and detailed description.

FIG. 1 is a diagram illustrating the data flow in one embodiment of the method of the present invention.

### DETAILED DESCRIPTION OF THE PRESENTLY PREFERRED EMBODIMENTS

The present invention provides a method of form authentication in which a user may be automatically authenticated to a web application without being prompted for login credentials. Particularly, the method of the present invention may improve the number and variety of web applications that can be successfully authenticated against by use of “client-side” processing. Client-side processing allows the login page scripting to execute prior to the form authentication process. The ability to execute client-side logic prior to authentication may significantly increase the number of web applications that can be successfully background authenticated against.

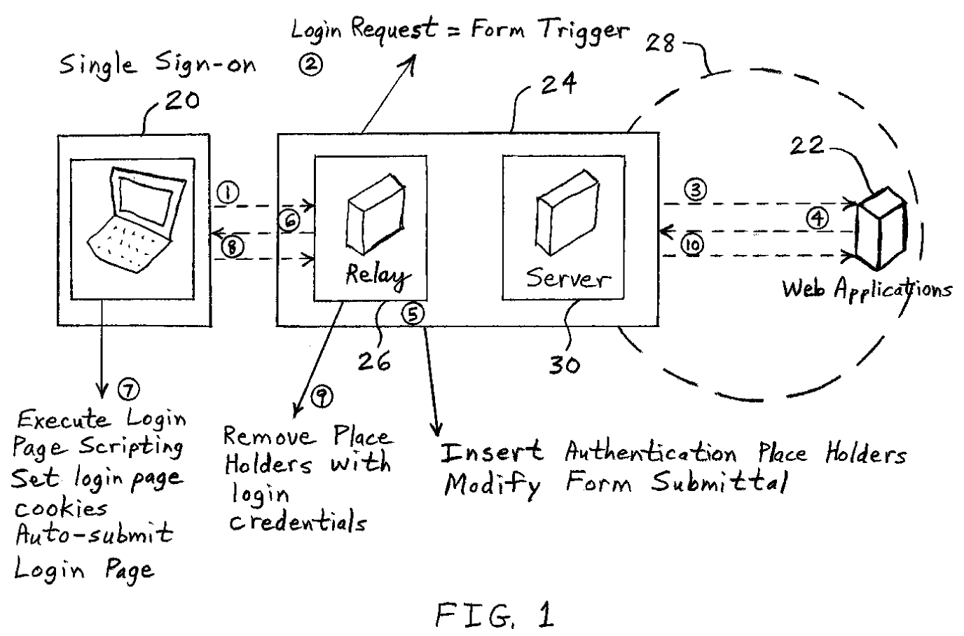

Referring to FIG. 1, there is shown a data flow diagram for one embodiment of a method of the present invention for client-side form authentication. As indicated by the dashed arrow labeled with the circled “1”, a user 20 may request access to a web application 22 through a web network server/relay 24. Web network server/relay 24 may validate the user's request via a Role Based Access Control model.

Web network relay 26 may be a secure entry point into web network 28. As its name suggests, the web network relay 26 may pass requests between the browser of client 20 and a web network server 30. Based on this architecture, web network users, such as user 20, may never communicate directly with web network server 30 or any other web network resource. Relay 26 may proxy all requests on behalf of the web network users to the internal web network resource. With this infrastructure in place, it is possible to move all web network resources (e.g., web servers, applications, services, etc) inside the corporate network, allowing access only through a web network relay.

Web network relay 26 may enforce the access control directives of web network server 30. Requests made by web network users may be forwarded to web network server 30 via web network relay 26. When web network server 30 responds with an “allow” or “deny” decision, web network relay 26 may make the request on behalf of the user or return a “denied access” message to the web network client. While web network server 30 may make the decisions regarding a user's access to web network resources, web network relay 26 may carry out the directives of server 30 by allowing or denying physical access to the web network resource.

Protecting web network resources from virus and hacker attacks may be a function of web network relay 26. Web network relay 26 may drop all malicious automated requests, such as hack and virus attacks, thereby protecting internal web network resources. In addition, relay 26 may be configured to run in “paranoid” mode which suppresses any identification of web network relay 26 to outside requests. Placement of web network relay 26 inside an organization's DMZ may allow other web resources to be moved securely inside the corporate firewall, thereby reducing the risk of viruses and malicious attacks.

Web network relay 26 may provide complete SSL (Secure Socket Layer) services to web network resources. Not only may web network resources be protected from unwanted access, the transfer of all data between web network relay 26 and the client browser may be encrypted with SSL services.

Relay 26 may be responsible for the rendering of web network pages and content. Content that is displayed within the web network may be rendered by relay 26, thereby off-loading web network server 30. Using this two tier approach may enable servers to scale the web network for thousands of users.

As indicated by the arrow labeled “2” in FIG. 1, if the requested URL for web application 22 matches the pre-defined “Form Trigger” (a specific URL designated to signal the start of single sign-on process) web network server/relay 24 may begin the background authentication process to the requested web application 22.

As indicated by the dashed arrow labeled “3”, web network server/relay 24 may forward the request for web application 22 to the internal web server.

As indicated by the dashed arrow labeled “4”, the internal web server may return the login page for web application 22 to web network server/relay 24.

As indicated by the arrow labeled “5”, web network server/relay 24 may modify the login page of web application 22. Web network server/relay 24 may replace all INPUT elements containing the user's credentials with “place holders”. Place holders may designate which INPUT elements should be replaced dynamically with the user's credential information. Web network server/relay 24 may modify SUBMIT element of the form to force the automatic submittal of the login page back to web network server/relay 24 for single sign-on processing.

As indicated by the dashed arrow labeled “6”, web network server/relay 24 may forward the login page back to the browser of end user 20. In one embodiment, no ActiveX or Java plug-ins are installed as part of the authentication process.

As indicated by the arrow labeled “7”, the login page of web application 22 may automatically load in the browser of end user 20. All web application cookies may be set in the browser of end user 20. All client-side javascripting may be executed by the browser of end user 20 before automatic form submittal. All Visual Basic scripting may be executed by the browser of end user 20 before automatic form submittal.

As indicated by the dashed arrow labeled “8”, the login page may be automatically submitted back to web network server/relay 24 (instead of to the web application server) when the login page completes loading and executing all client-side scripting. Thus, the client sign-on routine (script to execute) may be allowed to finish before executing sign-on

As indicated by the arrow labeled “9”, web network server/relay 24 may perform actions to the login page that was submitted by the end user as indicated at arrow 8. Namely, web network server/relay 24 may remove all place holders and replace the place holders with the user's credential information (i.e., actual data) stored on their directory service account or from their encrypted secret store. The credentials may never go out to the browser. Rather, the credentials may be stored in web network server/relay 24. Web network server/relay 24 may also modify the ACTION element of the login page to force the form elements to submit back to the internal web application server.

As indicated by the dashed arrow labeled “10”, web network server/relay 24 may submit the modified login page to the backend web application server for login processing. All subsequent responses may be forwarded between end user 20 and web application 22 without further modification. At this point, the single sign-on is complete, and the user may access other information systems on the same web site without having to repeat the sign-on process.

While the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

What is claimed is:

1. A form authentication method, comprising the steps of:
requesting access by a user to a web application through a relay device;
receiving at the relay device a login page for the web application;
using the relay device to modify the login page;
forwarding the login page to a browser of the user;
automatically loading the login page in the browser;
using the login page to execute client-side scripting;
automatically submitting the login page back to the relay device when the login page completes loading and executing client-side scripting; and
using the relay device to replace place holders from the login page with credential information of the user.
